(19) United States
(12) Patent Application Publication
(10) Pub. No.: US 2024/0388980 A1
(43) Pub. Date: Nov. 21, 2024

(54) APPARATUS AND METHOD TO HANDOVER WITHOUT RANDOM ACCESS BY AUTONOMOUS BEAM SELECTION FOR MOBILE INTEGRATED ACCESS AND BACKHAUL NODE IN WIRELESS COMMUNICATION SYSTEMS

(71) Applicant: Samsung Electronics Co., Ltd., Suwon-si (KR)

(72) Inventors: June HWANG, Suwon-si (KR); Anil AGIWAL, Mountain View, CA (US)

(21) Appl. No.: 18/665,912

(22) Filed: May 16, 2024

Related U.S. Application Data
(60) Provisional application No. 63/467,422, filed on May 18, 2023.

(51) Int. Cl. H04W 36/00; H04L 1/1812; H04W 72/1268; H04W 72/20

(52) U.S. Cl. CPC H04W 36/00725; H04L 1/1812; H04W 72/1268; H04W 72/20

(57) ABSTRACT

The disclosure relates to a 5G or 6G communication system for supporting a higher data transmission rate. A method performed by a user equipment (UE) in a wireless communication system is provided. The method includes receiving, from a base station, a high layer signaling including information enabling a multiplexing of a first hybrid automatic repeat request-acknowledgement (HARQ-ACK) information, receiving, from the base station, first downlink control information (DCI) scheduling physical uplink shared channel (PUSCH) repetitions, receiving, from the base station after the first DCI, second DCI indicating a physical uplink control channel (PUCCH), and transmitting, to the base station, the first HARQ-ACK information by multiplexing the first HARQ-ACK information in at least one PUSCH repetition other than a first PUSCH repetition among the PUSCH repetitions.

### CROSS-REFERENCE TO RELATED APPLICATION(S)

This application is based on and claims priority under 35 U.S.C. § 119 (e) of a U.S. Provisional application Ser. No. 63/467,422, filed on May 18, 2023, in the U.S. Patent and Trademark Office, the disclosure of which is incorporated by reference herein in its entirety.

### BACKGROUND

### 1. Field

This disclosure relates to an operation of a terminal and a base station in a wireless communication system. More particularly, the disclosure relates to a method and a device for performing handover of an access terminal when an integrated access and backhaul node is moved.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method enabling effective provision of a service in a mobile communication system.

Another aspect of the disclosure is to provide a terminal that performs handover without random access by using a particular beam at the time of movement of an integrated access and backhaul node, when a terminal in a connected mode receiving a service of the node performs handover without random access in the process where a cell of the node is changed.

Another aspect of the disclosure is to provide a method for performing handover of an access terminal when an integrated access and backhaul node is moved in a wireless communication system.

Another aspect of the disclosure is to provide a device and a method by which a service is effectively providable in a mobile communication system.

Another aspect of the disclosure is to provide a method for, when a cell is changed according to movement of an integrated access and backhaul node, performing, by terminals, handover to a changed cell without a separate random access operation.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station, a high layer signaling including information enabling a multiplexing of a first hybrid automatic repeat request-acknowledgement (HARQ-ACK) information, receiving, from the base station, first downlink control information (DCI) scheduling physical uplink shared channel (PUSCH) repetitions, receiving, from the base station after the first DCI, second DCI indicating a physical uplink control channel (PUCCH), and transmitting, to the base station, the first HARQ-ACK information by multiplexing the first HARQ-ACK information in at least one PUSCH repetition other than a first PUSCH repetition among the PUSCH repetitions.

In accordance with another aspect of the disclosure, a method performed by a base station in a wireless communication system is provided. The method includes transmitting, to a user equipment (UE), a high layer signaling including information enabling a multiplexing of a first hybrid automatic repeat request-acknowledgement (HARQ-ACK) information, transmitting, to the UE, first downlink control information (DCI) scheduling physical uplink shared channel (PUSCH) repetitions, transmitting, to the UE after the first DCI, second DCI indicating a physical uplink control channel (PUCCH), and receiving, from the UE, the first HARQ-ACK information, wherein the first HARQ-ACK information is multiplexed in at least one PUSCH repetition other than a first PUSCH repetition among the PUSCH repetitions.

In accordance with another aspect of the disclosure, a UE in a wireless communication system is provided. The UE includes a transceiver, memory storing one or more computer programs, and one or more processors communicatively coupled to the transceiver and the memory, wherein the one or more computer programs include computer-executable instructions that, when executed by the one or more processors, cause the UE to receive, from a base station, a high layer signaling including information enabling a multiplexing of a first hybrid automatic repeat request-acknowledgement (HARQ-ACK) information, receive, from the base station, first downlink control information (DCI) scheduling physical uplink shared channel (PUSCH) repetitions, receive, from the base station after the first DCI, second DCI indicating a physical uplink control channel (PUCCH), and transmit, to the base station, the first HARQ-ACK information by multiplexing the first HARQ-ACK information in at least one PUSCH repetition other than a first PUSCH repetition among the PUSCH repetitions.

In accordance with another aspect of the disclosure, base station in a wireless communication system is provided. The base station includes a transceiver, memory storing one or more computer programs, and one or more processors communicatively coupled to the transceiver and the memory, wherein the one or more computer programs include computer-executable instructions that, when executed by the one or more processors, cause the base station to transmit, to a user equipment (UE), a high layer signaling including information enabling a multiplexing of a first hybrid automatic repeat request-acknowledgement (HARQ-ACK) information, transmit, to the UE, first downlink control information (DCI) scheduling physical uplink shared channel (PUSCH) repetitions, transmit, to the UE after the first DCI, second DCI indicating a physical uplink control channel (PUCCH), and receive, from the UE, the first HARQ-ACK information, wherein the first HARQ-ACK information is multiplexed in at least one PUSCH repetition other than a first PUSCH repetition among the PUSCH repetitions.

In accordance with another aspect of the disclosure, one or more non-transitory computer-readable storage media storing computer-executable instructions that, when executed by one or more processors of a user equipment (UE), cause the UE to perform operations are provided. The operations include receiving, from a base station, a high layer signaling including information enabling a multiplexing of a first hybrid automatic repeat request-acknowledgement (HARQ-ACK) information, receiving, from the base station, first downlink control information (DCI) scheduling physical uplink shared channel (PUSCH) repetitions, receiving, from the base station after the first DCI, second DCI indicating a physical uplink control channel (PUCCH), and transmitting, to the base station, the first HARQ-ACK information by multiplexing the first HARQ-ACK information in at least one PUSCH repetition other than a first PUSCH repetition among the PUSCH repetitions.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of a long term evolution (LTE) system according to an embodiment of the disclosure;

FIG. 2 is a diagram illustrating a radio protocol structure of an LTE system according to an embodiment of the disclosure;

FIG. 3 is a diagram illustrating a structure of a next-generation mobile communication system according to an embodiment of the disclosure;

FIG. 4 is a diagram illustrating a radio protocol structure of a next-generation mobile communication system according to an embodiment of the disclosure;

FIG. 5 is a block diagram illustrating an internal structure of a terminal according to an embodiment of the disclosure;

FIG. 6 is a block diagram illustrating a configuration of a new radio (NR) base station according to an embodiment of the disclosure; and

FIG. 7 is a diagram illustrating a sequence of a handover procedure of a terminal, based on a movement operation of a mobile termination (MT) and distributed unit (DU) caused by movement of a mobile integrated access and backhaul (mIAB) node according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Furthermore, the size of each element does not completely reflect the actual size. In the respective drawings, the same or corresponding elements are provided with the same or corresponding reference numerals.

The advantages and features of the disclosure and ways to achieve them will be apparent by making reference to embodiments as described below in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined based on the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE advanced (LTE-A) systems may be described by way of example, but the embodiments of the disclosure may also be applied to other communication systems having similar technical backgrounds or channel types to the embodiments of the disclosure. Examples of such communication systems may include the 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the disclosure may be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, the “unit” in the embodiments may include one or more processors.

In the following description of the disclosure, terms and names defined in 5G system (5GS) and NR standards, which are the latest standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5^{th} generation mobile communication standards).

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

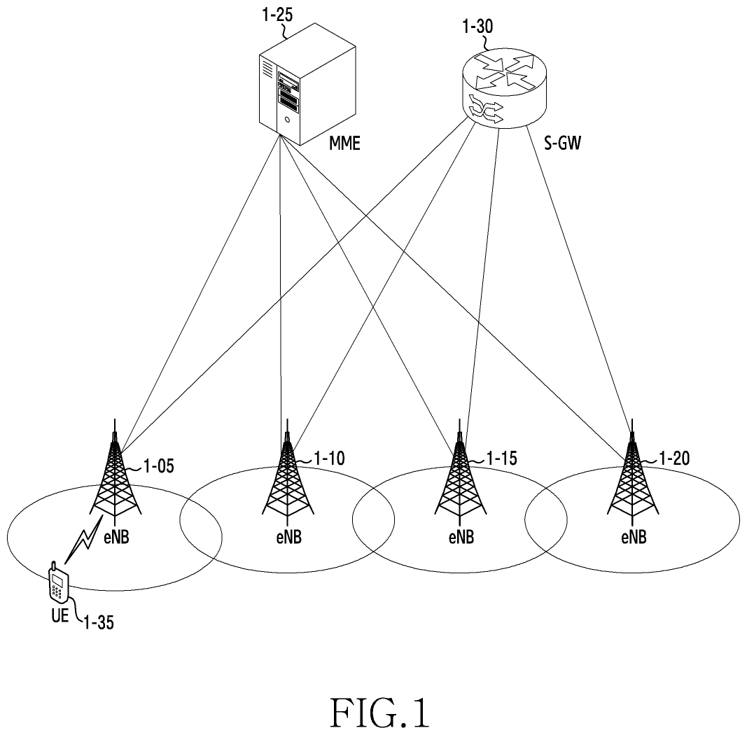

FIG. 1 illustrates a structure of an LTE system according to an embodiment of the disclosure.

Referring to FIG. 1, as illustrated therein, a radio access network of an LTE system may include next-generation base stations (evolved node Bs, hereinafter ENBs, node Bs, or base stations) 1-05, 1-10, 1-15, and 1-20, a mobility management entity (MME) 1-25, and a serving gateway (S-GW) 1-30. A user equipment (hereinafter UE or terminal) 1-35 may access an external network through the ENBs 1-05, 1-10, 1-15, and 1-20 and the S-GW 1-30.

In FIG. 1, the ENBs 1-05 to 1-20 may correspond to node Bs of the related art of a universal mobile telecommunication system (UMTS). The ENBs may be connected to the UE 1-35 through a radio channel, and perform more complicated roles than the node Bs of the related art. In the LTE system, since all user traffic including real-time services, such as voice over Internet protocol (VOIP) via the Internet protocol, may be serviced through a shared channel. Thus, a device that collects state information, such as buffer statuses, available transmit power states, and channel states of UEs, and performs scheduling accordingly may be required, and the ENBs 1-05 to 1-20 may serve as the device. In general, one ENB may control multiple cells. For example, in order to implement a transfer rate of 100 Mbps, the LTE system may use orthogonal frequency division multiplexing (hereinafter referred to as OFDM) as a radio access technology in a bandwidth of, for example, 20 MHz. Obviously, the example given above is not limiting. Furthermore, the ENBs 1-05 to 1-20 may employ an adaptive modulation & coding (AMC) scheme for determining a modulation scheme and a channel coding rate according to a channel state of the UE. The S-GW 1-30 is a device that provides a data bearer, and may generate or remove a data bearer under the control of the MME 1-25. The MME 1-25 is responsible for various control functions as well as a mobility management function for a UE, and may be connected to multiple base stations.

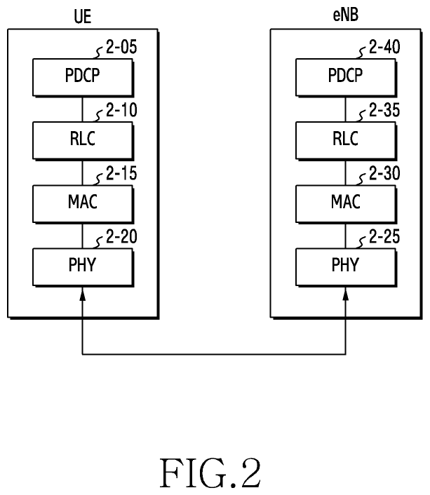

FIG. 2 illustrates a radio protocol structure of an LTE system according to an embodiment of the disclosure.

Referring to FIG. 2, a radio protocol of an LTE system may include a packet data convergence protocol (PDCP) 2-05 or 2-40, a radio link control (RLC) 2-10 or 2-35, and a medium access control (MAC) 2-15 or 2-30 in each of a UE and an ENB. The PDCP may serve to perform operations, such as internet protocol (IP) header compression/reconstruction. The main functions of the PDCP may be summarized as follows. Obviously, the example given below is not limiting.
Header compression and decompression: robust header compression (ROHC) only
Transfer of user data
In-sequence delivery of upper layer protocol data units (PDUs) at PDCP re-establishment procedure for RLC acknowledged mode (AM)
For split bearers in dual connectivity (DC) (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (RLC) 2-10 or 2-35 may reconfigure a PDCP protocol data unit (PDU) into an appropriate size to perform an automatic repeat request (ARQ) operation. The main functions of the RLC may be summarized as follows.
Transfer of upper layer PDUS
Error correction through ARQ (only for AM data transfer)
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 may be connected to several RLC layer devices configured in a single terminal, and perform operations of multiplexing RLC PDUs into a MAC PDU and demultiplexing a MAC PDU into RLC PDUs. The main functions of the MAC are summarized as follows. Obviously, the example given below is not limiting.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid ARQ (HARQ)
Priority handling between logical channels of one UE
Priority handling between UEs by means of dynamic scheduling
Multimedia broadcast and multicast service (MBMS) service identification
Transport format selection
Padding

A physical layer 2-20 or 2-25 may perform operations of channel-coding and modulating upper layer data, generating the same into OFDM symbols, and transmitting the same through a radio channel, or demodulating the OFDM symbols received through the radio channel, channel-decoding the same, and delivering the same to the upper layer. Obviously, the example given below is not limiting.

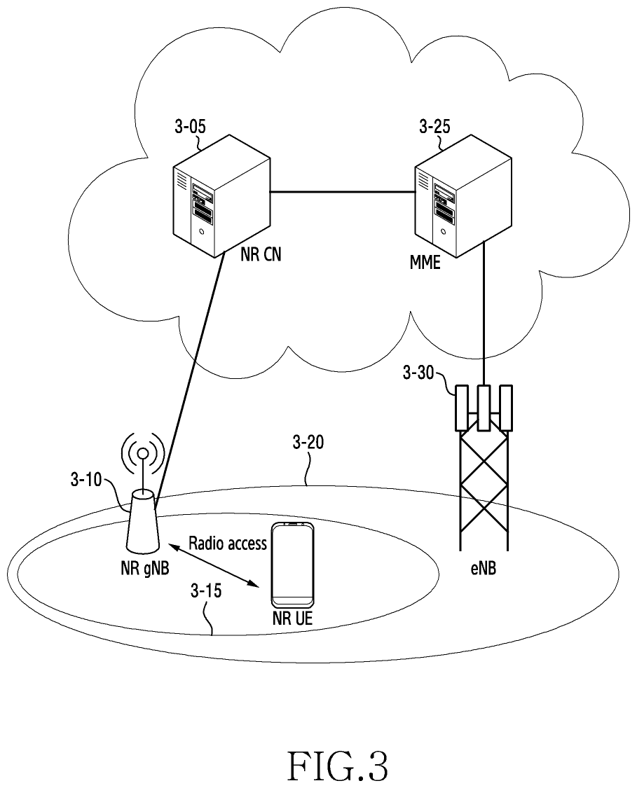

FIG. 3 illustrates a structure of a next-generation mobile communication system according to an embodiment of the disclosure.

Referring to FIG. 3, a radio access network of a next-generation mobile communication system (hereinafter NR or 5G) may include a new radio node B (hereinafter NR gNB or NR base station) 3-10, and a new radio core network (NR CN) 3-05. A new radio user equipment (NR UE or NR terminal) 3-15 may access an external network via the NR gNB 3-10 and the NR CN 3-05.

In FIG. 3, the NR gNB 3-10 may correspond to an evolved node B (eNB) of an LTE system of the related art. The NR gNB 3-10 may be connected to the NR UE 3-15 through a radio channel and provide outstanding services as compared to a node B of the related art. In the next-generation mobile communication system, since all user traffic may be serviced through a shared channel. Thus, a device that collects state information, such as buffer statuses, available transmit power states, and channel states of UEs, and performs scheduling accordingly may be required, and the NR gNB 3-10 may serve as the device. In general, one NR gNB may control multiple cells.

According to an embodiment of the disclosure, in order to implement ultrahigh-speed data transfer beyond the current LTE, the next-generation mobile communication system may provide a wider bandwidth than the existing maximum bandwidth. In addition, according to an embodiment of the disclosure, the NR gNB 3-10 may employ an orthogonal frequency division multiplexing (OFDM) as a radio access technology, and may additionally integrate a beamforming technology therewith. Furthermore, according to an embodiment of the disclosure, the NR gNB 3-10 may employ an adaptive modulation & coding (AMC) scheme for determining a modulation scheme and a channel coding rate according to a channel state of a UE. The NR CN 3-05 may perform functions, such as mobility support, bearer configuration, and quality of service (QOS) configuration. The NR CN 3-05 is a device responsible for various control functions, as well as a mobility management function for the UE, and may be connected to multiple base stations. In addition, the next-generation mobile communication system may interwork with the existing LTE system, and the NR CN 3-05 may be connected to an MME 3-25 via a network interface. The MME 3-25 may be connected to an eNB 3-30 that is an LTE base station in a network 3-20.

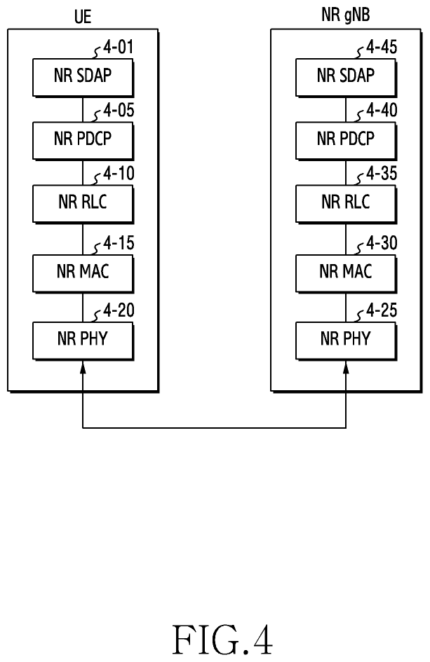

FIG. 4 illustrates a radio protocol structure of a next-generation mobile communication system according to an embodiment of the disclosure.

Referring to FIG. 4, a radio protocol of a next-generation mobile communication system may include an NR service data adaptation protocol (SDAP) 4-01 or 4-45, an NR PDCP 4-05 or 4-40, an NR RLC 4-10 or 4-35, an NR MAC 4-15 or 4-30, and an NR physical (PHY) layer 4-20 or 4-25 in each of a UE and an NR base station.

According to an embodiment of the disclosure, the main functions of the NR SDAP 4-01 or 4-45 may include at least one of functions below. Obviously, the example given below is not limiting.
Transfer of user plane data
Mapping between a QoS flow and a data radio bearer (DRB) for both DL and UL
Marking QoS flow ID in both DL and UL packets
Reflective QoS flow to DRB mapping for UL SDAP PDUs

With respect to the SDAP layer device, whether to use a header of the SDAP layer device or whether to use a function of the SDAP layer device for each PDCP layer device, each bearer, or each logical channel may be configured for the UE through an RRC message. In a case where an SDAP header is configured, a non-access stratum (NAS) quality of service (QOS) reflective configuration one-bit indicator (NAS reflective QoS) and an access stratum (AS) QoS reflective configuration one-bit indicator (AS reflective QoS) of the SDAP header may indicate the terminal to update or reconfigure mapping information relating to a QoS flow and a data bearer for uplink and downlink. The SDAP header may include QoS flow ID information indicating the QoS. The QoS information may be used as data processing priority, scheduling information, etc. for smoothly supporting the service.

According to an embodiment of the disclosure, the main functions of the NR PDCP 4-05 or 4-40 may include at least one of functions below. Obviously, the example given below is not limiting.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUS
Ciphering and deciphering
Timer-based SDU discard in uplink

According to an embodiment of the disclosure, the reordering of the NR PDCP device may refer to a function of reordering PDCP PDU received from a lower layer in an order based on PDCP sequence numbers (SNs). The reordering of the NR PDCP device may include at least one of a function of transferring data to an upper layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

According to an embodiment of the disclosure, the main functions of the NR RLC 4-10 or 4-35 may include some of functions below. Obviously, the example given below is not limiting.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

According to an embodiment of the disclosure, the in-sequence delivery of the NR RLC device may refer to a function of successively delivering RLC SDUs received from the lower layer to the upper layer. If one original RLC SDU is divided into several RLC SDUs and the RLC SDUs are received, the in-sequence delivery of the NR RLC device may include a function of reassembling the several RLC SDUs and transferring the reassembled RLC SDUs.

The in-sequence delivery of the NR RLC device may include at least one of a function of rearranging received RLC PDUs with reference to RLC sequence numbers (SNs) or PDCP sequence numbers (SNs), a function of rearranging order to record lost RLC PDUs, a function of reporting the state of lost RLC PDUs to a transmission side, and a function of requesting retransmission of lost RLC PDUs.

According to an embodiment of the disclosure, the in-sequence delivery of the NR RLC device may also include a function of, if there is a lost RLC SDU, sequentially transferring only RLC SDUs before the lost RLC SDU to an upper layer.

According to an embodiment of the disclosure, the in-sequence delivery of the NR RLC device may also include a function of, although there is a lost RLC SDU, if a predetermined timer has expired, sequentially transferring all the RLC SDUs received up to the current, to an upper layer.

According to an embodiment of the disclosure, the in-sequence delivery of the NR RLC device may also include a function of, although there is a lost RLC SDU, if a predetermined timer has expired, sequentially transferring all the RLC SDUs received up to the current, to an upper layer.

The NR RLC device may process RLC PDUs in a reception sequence, regardless of a sequence based on sequence numbers (out-of-sequence delivery). and then transfer the processed RLC PDUs to the NR PDCP device.

In a case where the NR RLC device receives segments, the NR RLC device may receive segments stored in a buffer or to be received in the future, reconfigure the segments to be one whole RLC PDU, process the RLC PDU, and then transfer the processed RLC PDU to the NR PDCP device.

According to an embodiment of the disclosure, the NR RLC layer may include no concatenation function, which may be performed in the NR MAC layer or replaced with a multiplexing function of the NR MAC layer.

According to an embodiment of the disclosure, the out-of-sequence delivery of the NR RLC device may include at least one of a function of directly delivering RLC SDUs received from a lower layer to an upper layer regardless of the order, a function of reassembling and delivering multiple RLC SDUs received, into which one original RLC SDU has been segmented, and a function of storing and reordering the RLC SNs or PDCP SNs of received RLC PDUs and recording lost RLC PDUs.

According to an embodiment of the disclosure, the NR MAC 4-15 or 4-30 may be connected to multiple NR RLC layer devices configured in one UE, and the main functions of the NR MAC may include at least one of functions below. Obviously, the example given below is not limiting.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

According to an embodiment of the disclosure, the NR PHY layer 4-20 or 4-25 may perform operations of channel-coding and modulating upper layer data, generating the same into OFDM symbols, and transmitting the same through a radio channel, or demodulating OFDM symbols received through the radio channel, channel-decoding the same, and delivering the same to the upper layer. Obviously, the example given above is not limiting.

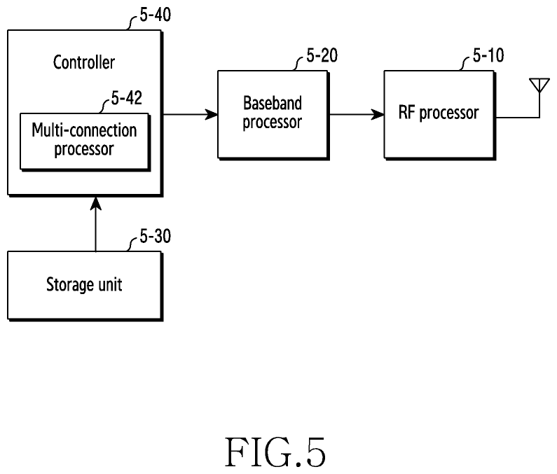

FIG. 5 is a block diagram illustrating a structure of a terminal according to an embodiment of the disclosure.

Referring to FIG. 5, the terminal may include a radio frequency (RF) processor 5-10, a baseband processor 5-20, a storage unit 5-30, and a controller 5-40. However, the disclosure is not limited to the example, and the terminal may include more or fewer elements, compared to the elements illustrated in FIG. 5.

The RF processor 5-10 may perform a function, such as signal band change, amplification, etc., for transmitting or receiving a signal through a wireless channel. The RF processor 5-10 may upconvert a baseband signal provided from the baseband processor 5-20, into an RF band signal, and then transmit the RF band signal through an antenna, and down-convert an RF band signal received through the antenna, into a baseband signal. For example, the RF processor 5-10 may include a transmission filter, a reception filter, an amplifier, a mixer, an oscillator, a digital-to-analog converter (DAC), an analog-to-digital converter (ADC), and the like. In the diagram, only one antenna is illustrated, but the terminal may include a plurality of antennas. Furthermore, the RF processor 5-10 may include a plurality of RF chains. Furthermore, the RF processor 5-10 may perform beamforming. To perform beamforming, the RF processor 5-10 may adjust the phase and size of each of signals transmitted or received through a plurality of antennas or antenna elements. In addition, the RF processor 5-10 may perform MIMO, and may receive several layers when a MIMO operation is performed.

The baseband processor 5-20 may perform a function of conversion between a baseband signal and a bitstream according to a physical layer specification of a system. For example, at the time of data transmission, the baseband processor 5-20 may generate complex symbols by encoding and modulating a transmission bitstream. In addition, at the time of data reception, the baseband processor 5-20 reconstructs a reception bit stream by demodulating and decoding a baseband signal provided from the RF processor 5-10. For example, in a case where an OFDM scheme is applied, at the time of data transmission, the baseband processor 5-20 may generate complex symbols by encoding and modulating a transmission bitstream, map the generated complex symbols to subcarriers, and then configure OFDM symbols through an inverse fast Fourier transform (IFFT) operation and cyclic prefix (CP) insertion. In addition, at the time of data reception, the baseband processor 5-20 may divide a baseband signal provided from the RF processor 5-10 by the units of OFDM symbols, reconstruct signals mapped to subcarriers through fast Fourier transform (FFT), and then reconstruct a reception bit stream through demodulation and decoding.

The baseband processor 5-20 and the RF processor 5-10 may transmit and receive a signal as described above. Accordingly, the baseband processor 5-20 and the RF processor 5-10 may be called a transmitter, a receiver, a transceiver, or a communication unit. Furthermore, at least one of the baseband processor 5-20 and the RF processor 5-10 may include a plurality of communication modules to support a plurality of different wireless access technologies. In addition, at least one of the baseband processor 5-20 and the RF processor 5-10 may include different communication modules to process signals in different frequency bands. For example, the different wireless access technologies may include wireless LAN (e.g., IEEE 802.11), cellular network (e.g., LTE), etc. Furthermore, the different frequency bands may include a super high frequency (SHF) (e.g., 2.NRHz, NRhz) band, a millimeter (mm) wave (e.g., 60 GHZ) band, etc. The terminal may transmit and/or receive a signal to/from a base station by using the baseband processor 5-20 and the RF processor 5-10, and the signal may include control information and data.

The storage unit 5-30 may store data, such as a basic program, an application program, and configuration information for an operation of the terminal. More particularly, the storage unit 5-30 may store information related to a second access node that performs wireless communication by using a second wireless access technology. The storage unit 5-30 may provide stored data according to a request of the controller 5-40. The storage unit 5-30 may be configured by a storage medium, such as read only memory (ROM), random access memory (RAM), hard disk, compact disc-ROM (CD-ROM), and digital versatile disc (DVD), or a combination of storage mediums. In addition, the storage unit 5-30 may be configured by a plurality of memories. According to an embodiment of the disclosure, the storage unit 5-30 may store a program for performing a method for the handover without random access by using a particular beam

The controller 5-40 may control overall operations of the terminal. For example, the controller 5-40 may transmit and/or receive a signal via the baseband processor 5-20 and the RF processor 5-10. In addition, the controller 5-40 may record and read data in and from the storage unit 5-30. To this end, the controller 5-40 may include at least one processor. For example, the controller 5-40 may include a communication processor (CP) performing control for communication, and an application processor (AP) controlling a higher layer, such as an application program. In addition, at least one element in the terminal may be implemented as a single chip. In addition, according to an embodiment of the disclosure, the controller 5-40 may include a multi-connection processor 5-42 that performs processing for operation in a multi-connection mode.

According to an embodiment of the disclosure, the controller 5-40 may control each element of the terminal to perform a method for positioning a particular terminal described later. For example, each element of the terminal may operate to perform embodiments of the disclosure described below.

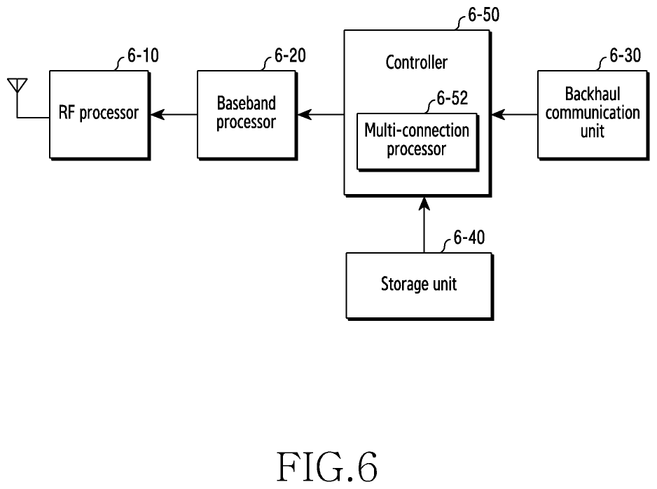

FIG. 6 is a block diagram illustrating a configuration of an NR base station according to an embodiment of the disclosure.

Referring to FIG. 6, the base station may include an RF processor 6-10, a baseband processor 6-20, a backhaul communication unit 6-30, a storage unit 6-40, and a controller 6-50. However, the disclosure is not limited to the example, and the base station may include more or fewer elements, compared to the elements illustrated in FIG. 5.

The RF processor 6-10 may perform a function, such as signal band change, amplification, etc., for transmitting and/or receiving a signal through a wireless channel. The RF processor 6-10 may upconvert a baseband signal provided from the baseband processor 6-20, into an RF band signal, and then transmit the RF band signal through an antenna, and down-convert an RF band signal received through the antenna, into a baseband signal. For example, the RF processor 6-10 may include a transmission filter, a reception filter, an amplifier, a mixer, an oscillator, a DAC, an ADC, and the like. In the diagram, only one antenna is illustrated, but a first access node may include a multiple of antennas. Furthermore, the RF processor 6-10 may include a plurality of RF chains. Furthermore, the RF processor 6-10 may perform beamforming. For beamforming, the RF processor 6-10 may adjust the phase and size of each signal transmitted and/or received through a multiple of antennas or antenna elements. The RF processor may perform a downlink MIMO operation by transmitting at least one layer.

The baseband processor 6-20 may perform a function of conversion between a baseband signal and a bitstream according to a physical layer specification of a first wireless access technology. For example, at the time of data transmission, the baseband processor 6-20 may generate complex symbols by encoding and modulating a transmission bitstream. In addition, at the time of data reception, the baseband processor 6-20 reconstructs a reception bit stream by demodulating and decoding a baseband signal provided from the RF processor 6-10. For example, in a case where an OFDM scheme is applied, at the time of data transmission, the baseband processor 6-20 may generate complex symbols by encoding and modulating a transmission bitstream, map the complex symbols to subcarriers, and then configure OFDM symbols through IFFT calculation and CP insertion. In addition, at the time of data reception, the baseband processor 6-20 may divide a baseband signal provided from the RF processor 6-10 by the units of OFDM symbols, reconstruct signals mapped to subcarriers through FFT, and then reconstruct a reception bit stream through demodulation and decoding. The baseband processor 6-20 and the RF processor 6-10 may transmit and receive a signal as described above. Accordingly, the baseband processor 6-20 and the RF processor 6-10 may be called a transmitter, a receiver, a transceiver, a communication unit, or a wireless communication unit. The base station may exchange a signal with a terminal by using the baseband processor 6-20 and the RF processor 6-10, and the signal may include control information and data.

The backhaul communication unit 6-30 may provide an interface for performing communication with other nodes within a network. The backhaul communication unit 6-30 may convert, into a physical signal, a bit stream transmitted from a main base station to another node, for example, an auxiliary base station, a core network, etc., and may convert a physical signal received from another node, into a bit stream.

The storage unit 6-40 may store data, such as a basic program, an application program, and configuration information for an operation of the main base station. More particularly, the storage unit 6-40 may store information on a bearer assigned to a connected terminal, a measurement result reported from a connected terminal, etc. In addition, the storage unit 6-40 may store information serving as a determination criterion of whether to provide or stop providing multi-connection to a terminal. The storage unit 6-40 may provide stored data according to a request of the controller 6-50. The storage unit 6-40 may provide stored data according to a request of the controller 6-50. The storage unit 6-40 may be configured by a storage medium, such as ROM, RAM, hard disk, CD-ROM, and a DVD, or a combination of storage mediums. In addition, the storage unit 6-40 may be configured by a plurality of memories. According to an embodiment of the disclosure, the storage unit 6-40 may store a program for performing a measurement reporting method based on an altitude event described above.

The controller 6-50 may control overall operations of the base station. For example, the controller 6-50 transmits and/or receives a signal via the baseband processor 6-20 and the RF processor 6-10, or via the backhaul communication unit 6-30. In addition, the controller 6-50 may record and read data in and from the storage unit 6-40. To this end, the controller 6-50 may include at least one processor (i.e., a multi-connection processor 6-42 that performs processing for operation in a multi-connection mode). In addition, at least one element in the base station may be implemented as a single chip. In addition, each element of the base station may operate to perform embodiments of the disclosure.

The following abbreviations may be used in the disclosure.
IAB node: integrated access and backhaul node
mIAB: mobile IAB
MT: mobile termination
DU: distributed unit
CU: centralized unit
HO: handover

The following assumptions may be used in the disclosure.

An mIAB node may be configured by an MT and a DU.

An mobile IAB node may be assumed to, when an mobile IAB node is moved, perform handover (HO) of the MT between a source donor centralized unit (CU) and a target donor CU and then perform migration of the DU.

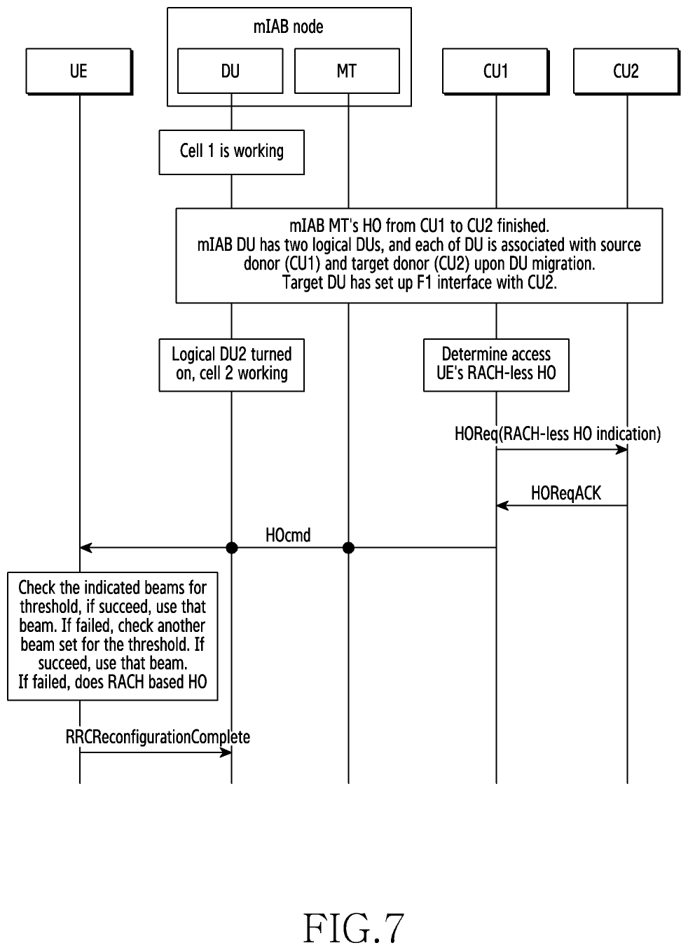

FIG. 7 illustrates a sequence of a handover procedure of a terminal, based on a movement operation of an MT and DU caused by movement of an mIAB node according to an embodiment of the disclosure.

Referring to FIG. 7, a mIAB node may be configured by a DU and an MT, and the MT may be connected to a cell of a parent IAB node to transmit or receive control plane (CP) and/or user plane (UP) data. The DU may configure a cell for UEs which receive a service of the mIAB node. Then, the DU may transmit DL data to the UEs or receive UL data therefrom. The DU may receive DL data from a donor node connected via the MT. Alternatively, the DU may transmit UL data to the donor node connected via the MT. The donor node may transmit or receive DL and UL data to or from a core network (CN).

A wireless connection section of the MT may be assumed to be connected to a DU controlled by the donor node (e.g., CU1) or a donor DU controlled by CU1. In FIG. 7, the connection of the mIAB node with the DU or donor DU may be omitted, and donor node CU1 or donor node CU2 may be directly represented.

According to a movement of the mIAB node, the MT connected to a cell of the DU or donor DU controlled by the existing donor node CU1 may undergo the performance degradation of the wireless connection section. The MT may change the connection to a cell of a DU or donor DU controlled by donor node CU2 according to the performance degradation of the wireless connection section. The above operation may be called handover of the MT of the mIAB node. This handover may proceed in a way similar to handover of the related art of a UE. After the handover of the MT is performed, the DU of the mIAB node may also change the donor node from CU1 to CU2. The process described above may be called migration of the DU.

In an embodiment of the disclosure, during the DU migration process, the DU may operate two logical DUs. A source logical DU may be a DU operating a cell associated with CU1 and a target logical DU may be a DU operating a cell associated with CU2. The cells operated by the respective DUs (e.g., the source logical DU and target logical DU) may be operated in the same time band, and if the cells are operated in the same time band, the respective DUs (e.g., the source logical DU and target logical DU) may operate the cell through different wireless physical resources. For example, through different wireless physical resources, a signal of the cell of the source logical DU may be transmitted and/or received and a signal of the cell of the target logical DU may be transmitted and/or received.

During the DU migration process, the target logical DU and CU2, that is, a target donor CU of the DU migration and an F1 interface may be setup. After activated cell configuration information of the target logical DU is received from CU2, the mIAB DU may start to operate a cell (e.g., cell 2 in FIG. 7) of the target logical DU. At an operation starting time point, a cell (e.g., cell 1 in FIG. 7) of the logical DU associated with the existing CU1 are already operating, and cell 2 are also operating, and thus there may be a time interval in which cell 1 and cell 2 simultaneously operate for a predetermined time (e.g., until cell 1 stops operating) after cell 2 starts to operate.

In the above situation, CU1 (the source donor CU of the DU at the time of DU migration) may determine handover for an access UE of the mIAB.

When handover for the access UE of the mIAB is determined, CU1 may obtain, from the mIAB DU, configuration information which relates to an activated cell operated by the target logical DU and has been agreed with CU2, and request a particular cell as a target cell from CU2 by using the obtained information at the time of HO preparation of the UE. In addition, CU1 may transfer, to CU2, at least one of an indicator indicating that particular beams are available for the particular target cell or information requesting use of the particular beams therefor. In addition, information transferred to CU2 may include at least one of information indicating that particular beams are usable in random access channel-less (rachless) HO or an indicator requesting use of the particular beams therein. In addition, information transferred to CU2 may include information requesting the UE to perform rachless HO. The pieces of information transferred to CU2 may be transferred after being included in a message on an Xn interface, for example, in an HO request message. The disclosure is not limited to the example.

The target donor CU (e.g., CU2) having received the information described above may write (or generate) configuration information at the target cell including pieces of particular beam information when the UE is admissible, is able to perform rachless HO, and determines to be able to perform rachless HO using a particular beam when the UE is to perform rachless HO. The configuration information may be called a handover (HO) command.

A HO command message may be transferred to CU1 again and then transferred to the UE via cell 1.

According to an embodiment of the disclosure, information that may be included in a HO command message and an operation in which a UE having received the information included in the HO command message performs handover to a particular cell (e.g., target cell) of a target logical DU may be described. However, the disclosure is not limited to the example below.

A HO command may include absolute radio frequency channel number (ARFCN) and physical cell identity (PCI) information of a target cell, and a UE may perform handover for a corresponding cell to the target cell.

### Opt 1.

An indicator or field meaning rachless HO may include at least one of the following pieces of information.
Beam-related information (A)
Beam-associated TA information and/or UL grant information (B)

Beam-related information may include at least one of an indicator indicating use of a beam having been used in a source cell, and as information on a beam of a target cell, which is required to be used in the target cell, a transmission configuration indicator (TCI) state ID as an ID of a beam in the source cell, which is identical to or is associated with a beam of a particular target cell, and an SSB or CSI-RS ID in the source cell, which is associated with the beam. Alternatively, ID information of an SSB associated with a particular beam in a target cell, the ID information meaning the particular beam of the target cell, may be included. The UE may recognize a beam in a target cell associated with beam information. The UE may perform UL transmission of a rachless HO through a particular beam.

A timing advance (TA) value to be applied when performing UL transmission by using a particular beam may be included for each beam or commonly for the beams. A particular TA value may be transferred, or use of a TA value of a particular timing advance group (TAG) having been used in the source cell may be indicated. An indication of a TA value may be a TAG ID of a pTAG or sTAG. If there is UL grant information, but a TA value is not configured or an indicator indicating use of a TA value being currently used in the source cell is included, an indication of a TA value may be an indication to use the TA value being currently used in the source cell.

UL grant information may correspond to indicating, for each beam or commonly for the beams, a wireless resource to be used when the UE performs UL transmission by using a particular beam. In addition, UL grant information may include at least one of a period, a duration, or an offset based on a particular reference time (e.g., a particular slot offset value or particular symbol offset value based on a system frame number (SFN)) together with particular frequency or BWP information. As an embodiment of the disclosure, a configured grant (CG) of configured grant type 1 or type 2 of a 5G communication system may be given as a UL grant. If a UL grant is not a pre-configured resource or information of repeatedly allocated resources is absent, the UE may monitor a physical downlink control channel (PDCCH) of the target cell. The UE may obtain a dynamic UL grant according to PDCCH monitoring and perform uplink (UL) transmission. In a case of monitoring a PDCCH, a HO command may include beam information (e.g., a TCI state ID or a synchronization signal block (SSB) index associated with the beam) of the target cell for monitoring the PDCCH. The UE may obtain UL grant information by monitoring a PDCCH through a beam of the target cell, and perform UL data transmission through a beam given through (A) or (D) for the UL grant.

An indicator or field meaning rachless HO may include at least one of the following pieces of information.
Information (C) on reference signal received power (RSRP) threshold value associated with beam (A)
Information (D) on target cell beam other than beam (A): A form representing beam information may include a beam indicator in the source cell or a beam indicator in the target cell in the same form of representing a previous beam (A).
UL grant and TA information (E) associated with other beam information
RACH configuration information (F) for normal RACH-based HO
Value (G) of rach-based HO conversion timer

A T304 timer (H) value may be configured in a reconfiguration WithSync field rather than a rachless HO field and transferred to the UE.

When a handover command is received, the UE may start a T304 timer and a rach-based HO conversion timer.

According to an embodiment of the disclosure, the UE may perform rachless HO as follows through rachless-related information. However, the disclosure is not limited to the example below.
If an RSRP measurement value of a random beam among indicated beams (A) of the target cell is equal to or greater than an RSRP threshold value (C),
   The UE may select a UL grant associated with a beam having an RSRP measurement value equal to or greater than the RSRP threshold value (C), and apply (B) a TA value associated with the beam having an RSRP measurement value equal to or greater than the RSRP threshold value (C) to transmit an RRCReconfigurationComplete message through the beam having an RSRP measurement value equal to or greater than the RSRP threshold value (C).
   If there are multiple beams satisfying the above RSRP condition, the UE may select a beam having the best RSRP value and perform the above operation.
   If the T304 timer (H) has expired or rach-based HO timer (G) has expired, the UE may perform a normal RACH-based HO based on RACH information configured as (F). The RACH configuration information may relate to contention-free random access (CFRA) or contention-based random access (CBRA). In addition, the UE may transmit an RRCReconfigurationComplete message to the target cell through a UL grant and TA value obtained after the RACH-based HO.
If there is no beam having a value equal to or greater than the RSRP threshold value among the beams (A), and there is a beam having a measured value equal to or greater than the RSRP threshold value (C) among beams indicated by (D),
   The UE may select a UL grant associated with a beam having a measured value equal to or greater than the RSRP threshold value (C), and apply (E) a TA value associated with the beam having a measured value equal to or greater than the RSRP threshold value (C) to transmit an RRCReconfigurationComplete message through the beam having a measured value equal to or greater than the RSRP threshold value (C).
   If there are multiple beams satisfying the above RSRP condition, the UE may select a beam having the best RSRP value and perform the above operation.
   If the T304 timer (H) has expired or rach-based HO timer (G) has expired, the UE may perform a normal RACH-based HO based on RACH information configured as (F). The RACH configuration information may relate to CFRA or CBRA. In addition, the UE may transmit an RRCReconfigurationComplete message to the target cell through a UL grant and TA value obtained after the RACH-based HO.
If there is no beam having a value equal to or greater than the RSRP threshold value among the beams (A), and there is also no beam having a measured value equal to or greater than the RSRP threshold value (C) among the beams indicated by (D),
   The UE may perform a RACH-based HO, based on the RACH configuration information provided by (F). The RACH configuration information may relate to CFRA or CBRA. In addition, the UE may transmit an RRCReconfigurationComplete message to the target cell through a UL grant and TA value obtained after the RACH-based HO.

### Opt 2.

The UE may assign UL grant and/or TA information to particular beams among beams based on a source DU or source cell in a HO command. For example, CU1 may transfer only (A), (B), (C), (F), (G), and (H) information in Opt 1 to the UE. However, the parts considered for the target cell in Opt 1 may be replaced with a source cell.

When a HO command is received, the UE may start (H) and (G) timers. Then, the UE operates as follows,
If an RSRP measurement value of a random beam among indicated beams (A) of the target cell is equal to or greater than an RSRP threshold value (C),
   The UE may select a UL grant associated with a beam having an RSRP measurement value equal to or greater than the RSRP threshold value (C), and apply (B) a TA value associated with the beam having an RSRP measurement value equal to or greater than the RSRP threshold value (C) to transmit an RRCReconfigurationComplete message through the beam having an RSRP measurement value equal to or greater than the RSRP threshold value (C).
   If there are multiple beams satisfying the above RSRP condition, the UE may select a beam having the best RSRP value and perform the above operation.
   If the T304 timer (H) has expired or rach-based HO timer (G) has expired, the UE may perform a normal RACH-based HO based on RACH information configured as (F). The RACH configuration information may relate to CFRA or CBRA. In addition, the UE may transmit an RRCReconfigurationComplete message through a UL grant and TA value obtained after the RACH-based HO, by using a beam having an RSRP measurement value equal to or greater than the RSRP threshold value (C).
If the RSRP measurement value of the indicated beam (A) is not equal to or greater than the given threshold value (C),
   The UE may perform a RACH-based HO, based on the RACH configuration information provided by (F). The RACH configuration information may relate to CFRA or CBRA. In addition, the UE may transmit an RRCReconfigurationComplete message to the target cell through a UL grant and TA value obtained after the RACH-based HO.

### Opt 3.

The UE may assign UL grant and/or TA information to particular beams among beams based on a target DU or target cell in a HO command. For example, CU1 may transfer only (A), (B), (C), (F), (G), and (H) information in Opt 1 to the UE.

When a HO command is received, the UE may start (H) and (G) timers. Then, the UE operates as follows,
If an RSRP measurement value of a beam among indicated beams (A) of the target cell is equal to or greater than an RSRP threshold value (C),
   The UE may select a UL grant associated with a beam having an RSRP measurement value equal to or greater than the RSRP threshold value (C), and apply (B) a TA value associated with the beam having an RSRP measurement value equal to or greater than the RSRP threshold value (C) to transmit an RRCReconfigurationComplete message through the beam having an RSRP measurement value equal to or greater than the RSRP threshold value (C).
   If there are multiple beams satisfying the above RSRP condition, the UE may select a beam having the best RSRP value and perform the above operation.
   If the T304 timer (H) has expired or rach-based HO timer (G) has expired, the UE may perform a normal RACH-based HO based on RACH information configured as (F). The RACH configuration information may relate to CFRA or CBRA. In addition, the UE may transmit an RRCReconfigurationComplete message to the target cell through a UL grant and TA value obtained after the RACH-based HO.
If the RSRP measurement value of the indicated beam (A) is not equal to or greater than the given threshold value (C),
   The UE may perform a RACH-based HO, based on the RACH configuration information provided by (F). The RACH configuration information may relate to CFRA or CBRA. In addition, the UE may transmit an RRCReconfigurationComplete message to the target cell through a UL grant and TA value obtained after the RACH-based HO.

### Opt 4.

All factors defined in Opt 1 may be defined (or configured) as information indicating a target DU cell to the UE. For example, an indicator or field meaning rachless HO may include at least one of the following pieces of information.
Beam-related information (A)
Beam (A)-associated TA information and/or UL grant information (B)
RSRP threshold value information (C) associated with beam (A)
Information (D) on target cell beam other than beam (A)
UL grant and TA information (E) associated with other beam information
RACH configuration information (F) for normal RACH-based HO
Value (G) of rach-based HO conversion timer

In addition, a reconfigurationWithSync field may include a T304 timer (H).

When a HO command including the information described above is received, the UE may start the (H) and (G) timers. Then, the UE operates as follows,
If an RSRP measurement value of a random beam among indicated beams (A) of the target cell is equal to or greater than an RSRP threshold value (C),
   The UE may select a UL grant associated with a beam having an RSRP measurement value equal to or greater than the RSRP threshold value (C), and apply (B) a TA value associated with the beam having an RSRP measurement value equal to or greater than the RSRP threshold value (C) to transmit an RRCReconfigurationComplete message through the beam having an RSRP measurement value equal to or greater than the RSRP threshold value (C).
   If there are multiple beams satisfying the above RSRP condition, the UE may select a beam having the best RSRP value and perform the above operation.
   If the timer (G) has expired and the T304 timer (H) has not expired, the UE may perform a normal RACH-based HO based on the RACH information configured as (F). The RACH configuration information may relate to CFRA or CBRA. In addition, the UE may transmit an RRCReconfigurationComplete message to the target cell through a UL grant and TA value obtained after the RACH-based HO.
If there is no beam having a value equal to or greater than the RSRP threshold value among the beams (A) and there is a beam having a measured RSRP value equal to or greater than the RSRP threshold value (C) among beams indicated by (D), or there is a beam having a measured RSRP value equal to or greater than the threshold value (C) with respect to beams configured to be associated with a UL grant and/or TA among beams not indicated as the beams (A),
   The UE may select a UL grant associated with a beam having a measured RSRP value equal to or greater than the RSRP threshold value (C), and apply (E) a TA value associated with the beam having a measured RSRP value equal to or greater than the RSRP threshold value (C) to transmit an RRCReconfigurationComplete message through the beam having a measured RSRP value equal to or greater than the RSRP threshold value (C).
   If there are multiple beams satisfying the above RSRP condition, the UE may select a beam having the best RSRP value and perform the above operation.
   If the timer (G) has expired and the T304 timer (H) has not expired, the UE may perform a normal RACH-based HO based on the RACH information configured as (F). The RACH configuration information may relate to CFRA or CBRA. In addition, the UE may transmit an RRCReconfigurationComplete message to the target cell through a UL grant and TA value obtained after the RACH-based HO.
If there is no beam having a value equal to or greater than the RSRP threshold value among the beams (A), and there is also no beam having a measured value equal to or greater than the RSRP threshold value (C) among the beams indicated by (D),
   The UE may perform a RACH-based HO, based on the RACH configuration information provided by (F). The RACH configuration information may relate to CFRA or CBRA. In addition, the UE may transmit an RRCReconfigurationComplete message to the target cell through a UL grant and TA value obtained after the RACH-based HO.
If the T304 timer (H) has expired while the RACH-based handover is performed, the UE may declare radio link failure (RLF) or HO failure and perform an RRC connection reestablishment procedure.

### Opt 5.

At least one of the following pieces of information may be defined (or configured) in an indicator or field meaning rachless HO as information indicating a target DU cell to the UE.
Beam-related information (A)
Beam (A)-associated TA information and/or UL grant information (B)
RSRP threshold value information (C) associated with beam (A)
RACH configuration information (F) for normal RACH-based HO
Value (G) of rach-based HO conversion timer

In addition, a reconfigurationWithSync field may include a T304 timer (H).

When a HO command including the information described above is received, the UE may start the (H) and (G) timers. Then, the UE operates as follows,
If an RSRP measurement value of a beam among indicated beams (A) of the target cell is equal to or greater than an RSRP threshold value (C),
   The UE may select a UL grant associated with a beam having an RSRP measurement value equal to or greater than the RSRP threshold value (C), and apply (B) a TA value associated with the beam having an RSRP measurement value equal to or greater than the RSRP threshold value (C) to transmit an RRCReconfigurationComplete message through the beam having an RSRP measurement value equal to or greater than the RSRP threshold value (C).
   If there are multiple beams satisfying the above RSRP condition, the UE may select a beam having the best RSRP value and perform the above operation.
   If the timer (G) has expired and the T304 timer (H) has not expired, the UE may perform a normal RACH-based HO based on the RACH information configured as (F). The RACH configuration information may relate to CFRA or CBRA. In addition, the UE may transmit an RRCReconfigurationComplete message to the target cell through a UL grant and TA value obtained after the RACH-based HO.
If none of the RSRP measurement values of the indicated beams (A) of the target cell is equal to or greater than an RSRP threshold value (C),
   The UE may perform a RACH-based HO, based on the RACH configuration information provided by (F). The RACH configuration information may relate to CFRA or CBRA. In addition, the UE may transmit an RRCReconfigurationComplete message to the target cell through a UL grant and TA value obtained after the RACH-based HO.
If the T304 timer (H) has expired while the RACH-based handover is performed, the UE may declare RLF or HO failure and perform an RRC connection reestablishment procedure.

In a case of a beam indicated by (D) in the above options (e.g., Opt 1 to Opt 5) according to an embodiment of the disclosure, there may be no separate beam indication. The UE may consider, as a beam to be measured, a beam other than the beams indicated in the previous stage (e.g., (A)), rather than the beams indicated by (D).

In a case of an RSRP threshold value in the above options, a threshold value used to measure a beam indicated by (A) and a threshold value used to measure a beam indicated by (D) may be different from each other. A threshold value different from (C) may be indicated in a rachless HO configuration in a HO command message transferred to the UE by a network, and the UE may use the separate threshold value to measure validity of a beam indicated by (D).

In the above options, when the UE performs RACH-based HO while attempting to rachless HO, the UE may release at least one of (E) information or the pieces of UL grant and/or TA information (e.g., (B)) associated with beams configured by (A) and (D). Thereafter, the UE may not use the at least one piece of information when RACH-based HO is performed. In the options, in relation to a definition for a time point at which rachless HO is completed, in a case where a pre-configured resource is used as a UL grant, if the UE transmits an RRCReconfigurationComplete message to the target cell and receives downlink control information (DCI) indicated by a C-RNTI from a network to obtain UL grant information or DL scheduling information, the UE may consider that the rachless HO is completed. In an embodiment of the disclosure, if the UE transmit an RRCReconfigurationComplete message to the target cell, and receives a contention resolution identification medium access control (MAC) control element (CE) among DL MAC CEs, the UE may consider that the rachless HO is completed.

It should be noted that the configuration diagrams, illustrative diagrams of control/data signal transmission methods, and illustrative diagrams of operation procedures as illustrated in FIGS. 1 to 7 are not intended to limit the scope of protection of the disclosure. For example, all the constituent units or operation steps shown in FIGS. 1 to 7 should not be construed as essential elements for implementing the disclosure, and even when including only some of the elements, the disclosure may be implemented without impairing the true nature of the disclosure.

The methods according to the embodiments of the disclosure described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to random access memory, non-volatile memory including flash memory, read only memory (ROM), electrically erasable programmable ROM (EEPROM), magnetic disc storage device, compact disc (CD)-ROM, a digital versatile disc (DVD) or other optical storage device, and a magnetic cassette. Alternatively, it may be stored to memory combining part or all of those recording media. A plurality of memories may be included.

In addition, the program may be stored in an attachable storage device accessible via a communication network, such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the specific embodiments of the disclosure, the components included in the disclosure are expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

Meanwhile, while the specific embodiment has been described in the explanations of the disclosure, it will be noted that various changes may be made therein without departing from the scope of the disclosure. Therefore, the scope of the disclosure is not limited and defined by the described embodiment and is defined not only the scope of the claims as below but also their equivalents.

The embodiments of the disclosure described and shown in the specification and the drawings are merely specific examples that have been presented to easily explain the technical contents of the disclosure and help understanding of the disclosure, and are not intended to limit the scope of the disclosure. For example, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. As an example, a part of embodiment 1 of the disclosure may be combined with a part of embodiment 2 to operate a base station and a terminal. Furthermore, although the above embodiments have been presented based on the frequency division duplex (FDD) LTE system, other variants based on the technical idea of the above embodiments may also be implemented in other systems, such as time division duplex (TDD) LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and the scope of the disclosure as defined by the appended claims and their equivalents.

What is claimed is:

1. A method performed by a user equipment (UE) in a wireless communication system, the method comprising:
receiving, from a base station, a high layer signaling including information enabling a multiplexing of a first hybrid automatic repeat request-acknowledgement (HARQ-ACK) information;
receiving, from the base station, first downlink control information (DCI) scheduling physical uplink shared channel (PUSCH) repetitions;
receiving, from the base station after the first DCI, second DCI indicating a physical uplink control channel (PUCCH); and
transmitting, to the base station, the first HARQ-ACK information by multiplexing the first HARQ-ACK information in at least one PUSCH repetition other than a first PUSCH repetition among the PUSCH repetitions.

2. The method of claim 1, further comprising:
transmitting, to the base station, UE capability information including information indicating whether the UE supports the multiplexing.

3. The method of claim 1, wherein the first HARQ-ACK information is for a physical downlink shared channel (PDSCH) scheduled by the second DCI.

4. The method of claim 1, further comprising:
transmitting, to the base station, a second HARQ-ACK information including a negative acknowledgment (NACK) value.

5. The method of claim 4, wherein the second HARQ-ACK information includes the NACK value, in case that a condition associated with a processing time for the multiplexing is not satisfied.

6. A method performed by a base station in a wireless communication system, the method comprising:
transmitting, to a user equipment (UE), a high layer signaling including information enabling a multiplexing of a first hybrid automatic repeat request-acknowledgement (HARQ-ACK) information;
transmitting, to the UE, first downlink control information (DCI) scheduling physical uplink shared channel (PUSCH) repetitions;
transmitting, to the UE after the first DCI, second DCI indicating a physical uplink control channel (PUCCH); and
receiving, from the UE, the first HARQ-ACK information, wherein the first HARQ-ACK information is multiplexed in at least one PUSCH repetition other than a first PUSCH repetition among the PUSCH repetitions.

7. The method of claim 6, further comprising:
receiving, from the UE, UE capability information including information indicating whether the UE supports the multiplexing.

8. The method of claim 6, wherein the first HARQ-ACK information is for a physical downlink shared channel (PDSCH) scheduled by the second DCI.

9. The method of claim 6, further comprising:
receiving, from the UE, a second HARQ-ACK information including a negative acknowledgment (NACK) value.

10. The method of claim 9, wherein the second HARQ-ACK information includes the NACK value, in case that a condition associated with a processing time for the multiplexing is not satisfied.

11. A user equipment (UE) in a wireless communication system, the UE comprising:
a transceiver; and
at least one processor coupled with the transceiver and configured to:
receive, from a base station, a high layer signaling including information enabling a multiplexing of a first hybrid automatic repeat request-acknowledgement (HARQ-ACK) information,
receive, from the base station, first downlink control information (DCI) scheduling physical uplink shared channel (PUSCH) repetitions,
receive, from the base station after the first DCI, second DCI indicating a physical uplink control channel (PUCCH), and
transmit, to the base station, the first HARQ-ACK information by multiplexing the first HARQ-ACK information in at least one PUSCH repetition other than a first PUSCH repetition among the PUSCH repetitions.

12. The UE of claim 11, wherein the at least one processor is further configured to:
transmit, to the base station, UE capability information including information indicating whether the UE supports the multiplexing.

13. The UE of claim 11, wherein the first HARQ-ACK information is for a physical downlink shared channel (PDSCH) scheduled by the second DCI.

14. The UE of claim 11, wherein the at least one processor is further configured to:
transmit, to the base station, a second HARQ-ACK information including a negative acknowledgment (NACK) value.

15. The UE of claim 14, wherein the second HARQ-ACK information includes the NACK value, in case that a condition associated with a processing time for the multiplexing is not satisfied.

16. A base station in a wireless communication system, the base station comprising:
a transceiver; and
at least one processor coupled with the transceiver and configured to:
transmit, to a user equipment (UE), a high layer signaling including information enabling a multiplexing of a first hybrid automatic repeat request-acknowledgement (HARQ-ACK) information,
transmit, to the UE, first downlink control information (DCI) scheduling physical uplink shared channel (PUSCH) repetitions,
transmit, to the UE after the first DCI, second DCI indicating a physical uplink control channel (PUCCH), and
receive, from the UE, the first HARQ-ACK information, wherein the first HARQ-ACK information is multiplexed in at least one PUSCH repetition other than a first PUSCH repetition among the PUSCH repetitions.

17. The base station of claim 16, wherein the at least one processor is further configured to:
receive, from the UE, UE capability information including information indicating whether the UE supports the multiplexing.

18. The base station of claim 16, wherein the first HARQ-ACK information is for a physical downlink shared channel (PDSCH) scheduled by the second DCI.

19. The base station of claim 16, wherein the at least one processor is further to:
receive, from the UE, a second HARQ-ACK information including a negative acknowledgment (NACK) value.

20. The base station of claim 19, wherein the second HARQ-ACK information includes the NACK value, in case that a condition associated with a processing time for the multiplexing is not satisfied.
